(19) United States
(12) Patent Application Publication
(10) Pub. No.: US 2024/0322644 A1
(43) Pub. Date: Sep. 26, 2024

(54) Locking Mechanism, Electric Motor Drive Unit, Vehicle And Method For Locking A Shaft Of A Drive Train

(71) Applicant: Vitesco Technologies GmbH, Regensburg (DE)

(72) Inventors: Christof Heeger, Gelnhausen (DE); Karl Martin Fritsch, Frankfurt (DE)

(73) Assignee: Vitesco Technologies GmbH, Regensburg (DE)

(21) Appl. No.: 18/680,189

(22) Filed: May 31, 2024

Related U.S. Application Data
(63) Continuation of application No. PCT/EP2022/083924, filed on Nov. 30, 2022.

(30) Foreign Application Priority Data
Dec. 2, 2021 (DE) 10 2021 213 737.7

(51) Int. Cl. H02K 7/10; H02K 7/00

(52) U.S. Cl. CPC H02K 7/10; H02K 7/003; H02K 7/006

(57) ABSTRACT

The disclosure relates to a blocking mechanism of a vehicle. A form-fitting element positioned between a blocking actuator and a blockable shaft of a drivetrain. The form-fitting element can be actuated in an axial stroke movement and longitudinally in relation to the shaft. The form fitting element can bear against an end face of a shaft-mounted complement to which the form-fitting element can be partially form-fittingly coupled and be biased longitudinally in relation to the shaft and in defined fashion against the shaft-mounted complement by at least one elastic force transmission portion so as to be able to enter a latching engagement.

### CROSS-REFERENCE TO RELATED APPLICATIONS

This application claims the benefit of PCT Application PCT/EP2022/083924, filed Nov. 30, 2022, which claims priority to German Application 10 2021 213 737.7, filed Dec. 2, 2021. The disclosures of the above applications are incorporated herein by reference.

### TECHNICAL FIELD

The disclosure relates to a blocking mechanism, to an electric motor drive unit, to a vehicle, and to a method for blocking a shaft of a drivetrain.

### SUMMARY

The disclosure provides an improved blocking mechanism, for example used in a vehicle. One aspect of the disclosure provides a blocking mechanism, for a vehicle or a parking lock of a vehicle. A form-fitting element is actuated in an axial stroke movement and longitudinally in relation to the shaft between a blocking actuator and a blockable shaft of a drivetrain. The form-fitting element may be at least partially form-fittingly coupled to a shaft-mounted complement within a form-fitting region in order to block the shaft. In a state in which the form-fitting element bears against the end face of the shaft-mounted complement, the form-fitting element may be biased longitudinally in relation to the shaft against the shaft-mounted complement by at least one elastic force transmission portion in defined manner and so as to be able to enter a latching engagement.

In a blocked state of the shaft, in which the form-fitting element and the shaft-mounted complement engage in one another in the form-fitting region of the blocking mechanism, the form-fitting element is supported against a housing portion of an electric motor drive unit, on which the blocking actuator is mounted.

In the form-fitting region and in the circumferential direction of the shaft, the blocking mechanism has a movement clearance between the form-fitting element and the shaft-mounted complement. The movement clearance, in combination with said or the aforementioned bias of the form-fitting element against the shaft-mounted complement, make it possible to latch the form-fitting element into the shaft-mounted complement or to couple the form-fitting element to the shaft-mounted complement.

In this case, a shaft-mounted complement is understood to mean a shaft-mounted mating piece with respect to the form-fitting element. The mating piece has a correspondingly complementary form or shape to the form-fitting element in the form-fitting region. The complement may be a correspondingly shaped portion of the shaft itself or a separate and correspondingly shaped element which is coupled to the shaft and form-fittingly interacts with the form-fitting element.

Here, an elastic force transmission portion is a mechanical energy store for elastically biasing the form-fitting element against the shaft-mounted complement, for instance in the form of at least one separate spring or one separate spring element and/or in the form of at least one spring element portion integrated in the form-fitting element.

This energy store biases the form-fitting element against the shaft-mounted complement until the shaft assumes or reaches a suitable alignment, relative to the form-fitting element, for a form fit. As soon as such an alignment exists, this energy store presses the form-fitting element into the shaft-mounted complement to produce a latching engagement, with the result that the shaft is blocked.

The blocking mechanism enables a compact and inexpensive design, which saves on installation space, within a drivetrain, of a vehicle.

Moreover, the blocking mechanism can be implemented in a way which saves on energy, since it is not necessary for the actuator to apply any high adjustment forces for the biasing. When the form-fitting element is coupled to the shaft-mounted complement, specifically only the form-fitting element, and not also the element to be blocked of a drivetrain, is moved.

In some examples, the shaft-mounted complement is arranged in the region of an end of the shaft. The blocking actuator may be mounted on the housing portion in a manner situated opposite the end of the shaft.

In some implementations, the form-fitting element is moreover arranged coaxially with the shaft. This enables a particularly compact design of an electric motor drive unit, of a vehicle, that has such a blocking mechanism.

The form-fitting element may be shaped in the form of an annular element that runs around in closed fashion and advantageously may be arranged coaxially with the blockable shaft.

The form-fitting element has an inner profiling which form-fittingly interacts with a profiling, complementary to the inner profiling, of the shaft-mounted complement in the form-fitting region.

The form-fitting element also has an outer profiling which has a complementary shape to a guide portion. This guide portion may be a portion of the blocking actuator itself, which is mounted on or fastened to the housing portion. As an alternative to this, the guide portion may be shaped on or integrated in the housing portion itself. This guide portion longitudinally guides the form-fitting element for the axial stroke movement in relation to the shaft. Therefore, the form-fitting element—depending on the implementation of this guide portion—is indirectly or directly supported on the housing portion.

In some examples, the form-fitting element is supported against a housing portion of an electric motor housing or of a (reduction) gear housing. The blocking mechanism is advantageously integrated in the electric motor housing or (reduction) gear housing.

In some examples, the form-fitting element has an electrically actuatable design.

The form-fitting element is attached to a movement mechanism of the blocking actuator via the at least one elastic force transmission portion or the at least one mechanical energy store, which movement mechanism brings about the axial stroke movement of the form-fitting element.

The movement mechanism may have a screw drive for generating the axial stroke movement.

As an alternative to this, the movement mechanism may have a plunger coil for generating the axial stroke movement.

Furthermore, an electric motor drive unit having a blocking mechanism of the type described above is disclosed.

A vehicle having such an electric motor drive unit or a blocking mechanism of the type described above is also disclosed.

A vehicle is to be understood to mean any type of vehicle or motor vehicle that is operated by an electric motor, but in particular passenger motor cars and/or utility vehicles. These may be partially autonomously or fully autonomously operated vehicles.

A method for blocking a shaft of a drivetrain, of a vehicle, by way of a blocking mechanism of the type described above is also disclosed.

During this method, the form-fitting element is brought into latching engagement with the shaft-mounted complement, utilizing the movement clearance, up to a maximum rotational speed of the shaft that depends on the movement clearance, in that the form-fitting element, in a state in which it bears against an end face of the shaft-mounted complement, is biased longitudinally in relation to the shaft and with a definable force against the shaft-mounted complement via the at least one elastic force transmission means until a latching engagement is obtained.

In some examples, if the vehicle starts to move from a stationary position, a shaft of the vehicle is blocked up to a maximum speed of the vehicle that depends on the movement clearance.

The blocking actuator needs to apply only a relatively small force for biasing purposes. The applied biasing force needs only to be great enough that it brings the form-fitting element—utilizing said movement clearance—into a force fit with the shaft-mounted complement in an available period of time that depends on a rotational speed of the shaft or vehicle speed.

It is also the case that only the form-fitting element of the blocking actuator, and not also the shaft to be blocked of the drivetrain, is moved.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows an exemplary blocking mechanism in a perspective sectional illustration;

FIG. 2 shows the exemplary blocking mechanism shown in FIG. 1 in a planar sectional illustration;

FIG. 3 shows the blocking mechanism shown in FIG. 1 in a further, planar sectional illustration;

FIG. 4 shows a form-fitting region of the exemplary blocking mechanism; and

FIG. 5 shows an electric motor drive unit of a drivetrain.

Like reference symbols in the various drawings indicate like elements.

### DETAILED DESCRIPTION

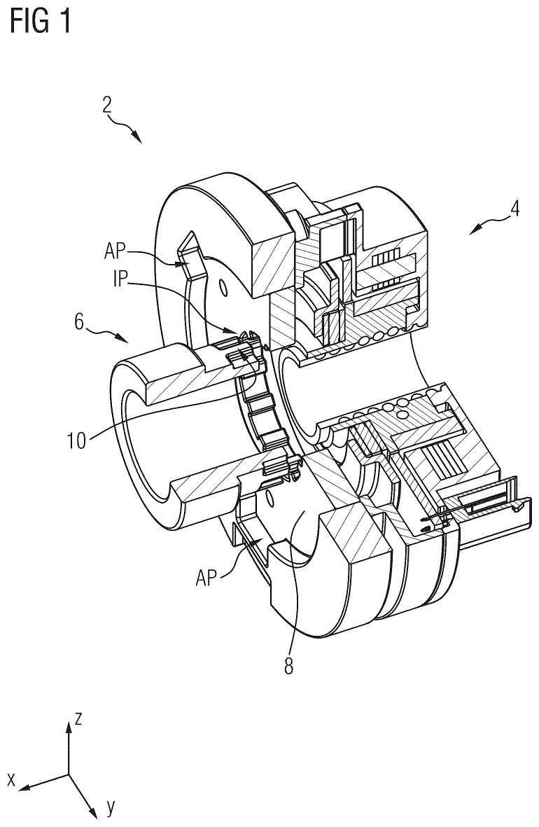

FIG. 1 depicts a blocking mechanism 2, in the case of which a blocking actuator 4 interacts with a blockable shaft 6, for instance in the form of a hollow shaft of a drivetrain.

The blocking actuator 4 includes a form-fitting element 8, which is electrically actuatable in an axial stroke movement in the longitudinal direction X-X and longitudinally in relation to the shaft 6.

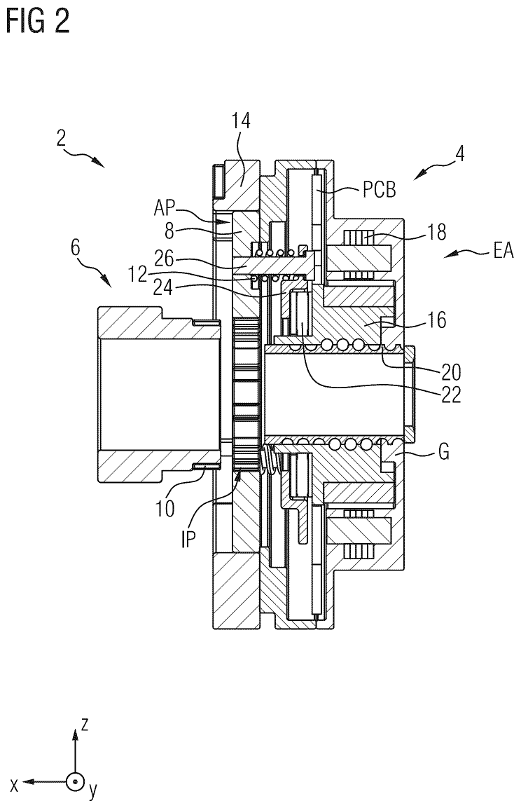

FIG. 2 shows this form-fitting element 8 in a state in which it is not coupled to the shaft 6. The shaft 6 is therefore not in the blocked state.

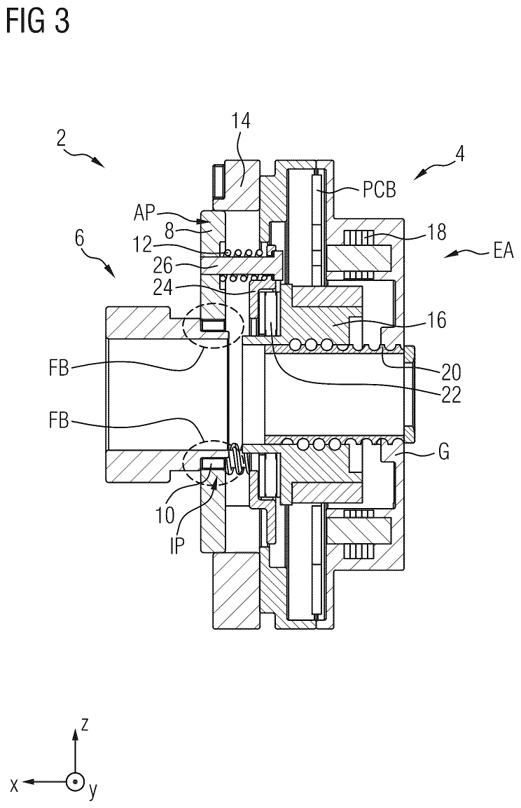

By contrast, FIG. 3 shows this form-fitting element 8 in a state in which it is operatively connected or joined to the shaft 6, in which state, i.e., the form-fitting element 8 and the shaft 6 partially form-fittingly engage in one another in a form-fitting region FB, with the result that the shaft 6 is blocked.

The form-fitting element 8 is shaped in the form of an annular element which runs around in closed fashion and has a recess or opening which runs around and is intended for the form fit. In this recess—distributed over the circumference thereof and at regular intervals—there are formed radial, inwardly projecting bar- or tooth- or claw-like form-fitting elements, which form an inner profiling IP of the form-fitting element 8 and can be brought into a form fit with a shaft-mounted complement in the form-fitting region FB.

The shaft-mounted complement is shaped in or on the shaft 6 itself in a region of that end of the shaft 6 that faces toward the blocking actuator 4, specifically in the form of a shaft outer profiling 10 with a complementary shaping to the inner profiling IP.

The form-fitting element 8 and the shaft 6 engage form-fittingly in one another similar to a spur gear toothing.

For the axial stroke movement in the longitudinal direction X-X, the form-fitting element 8 is guided longitudinally in relation to the shaft 6 or in its longitudinal direction X-X via, for example, three radial, outwardly projecting, claw-like form-fitting elements which are at a regular spacing from one another and are integrally molded or shaped on the outer circumference of said guide element, in a guide portion 14 that is integrally molded or shaped in corresponding or complementary fashion to these form-fitting elements. These claw-like form-fitting elements form an outer profiling AP of the form-fitting element 8.

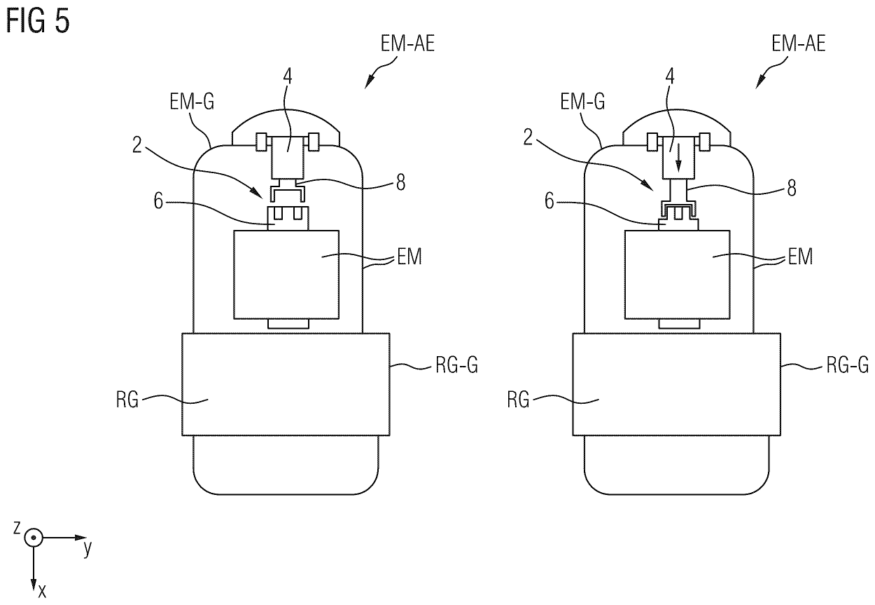

The guide portion 14 is for example in the form of a portion of the blocking actuator 4 and as such is mounted, for example, on a housing portion EM-G of an electric motor EM of an electric motor drive unit EM-AE (see FIG. 5). In the blocked state of the shaft 6, the form-fitting element 8 is supported against the housing portion EM-G of the electric motor EM via this guide portion 14. In the blocked state of the shaft 6, therefore, both static and dynamic torque loads of the drivetrain are introduced into the housing portion or the housing EM-G of the electric motor EM via this guide portion 14.

FIG. 5 depicts such an electric motor drive unit EM-AE of a drivetrain, of a vehicle, which has the electric motor EM, a reduction gear RG and the proposed blocking mechanism 2.

The blocking actuator 4 is arranged opposite the end of the shaft 6 and coaxially with the shaft and is mounted on the housing portion EM-G of the electric motor EM (see also FIGS. 1 to 3). The blocking mechanism 2 is thus advantageously integrated in the electric motor EM. The blocking actuator 4 is integrated in the electric motor housing EM-G. As regards the aforementioned vehicle, FIG. 5 thus depicts a parking lock integrated in the electric motor EM.

Via for example three helical springs 12—oriented in the longitudinal direction X-X—the form-fitting element 8 is attached to an electric drive EA of the blocking actuator 4 elastically in the longitudinal direction X-X. These individual helical springs 12 (mechanical energy stores) are guided via an associated pin element 26 and are at a regular spacing from one another in the circumferential direction of the form-fitting element 8. These individual pin elements 26 connect the form-fitting element 8 to an annular external disk element 24, which is at a spacing from the form-fitting element 8 in the longitudinal direction X-X, runs around in closed fashion and has a peripheral recess. These helical springs 12 are arranged between this disk element 24 and the form-fitting element 8 with a certain bias. The pin elements 26 extend through the disk element 24 to the form-fitting element 8, in which they are anchored.

The electric drive EA of the blocking actuator 4 has a stator 18, which drives a rotor 16 lying inside it by way of permanent magnets. The rotor 16 is in the form of a nut or threaded nut of a screw drive which can be moved relative to the shaft end along an—advantageously hollow—threaded spindle 20, with which it interacts, in the longitudinal direction X-X, depending on its direction of rotation (rotating counterclockwise or clockwise). This screw drive converts a rotational movement of the rotor 16 into an axial movement of the rotor 16 in the longitudinal direction X-X.

An axial bearing 22, via which the rotor 16 interacts with the disk element 24, which can be moved solely in the longitudinal direction X-X, is arranged between the rotor 16 and the disk element 24. The axial bearing 22 enables a low-friction rotational movement of the rotor 16 relative to the disk element 24, which performs a translational movement in the longitudinal direction X-X in the process.

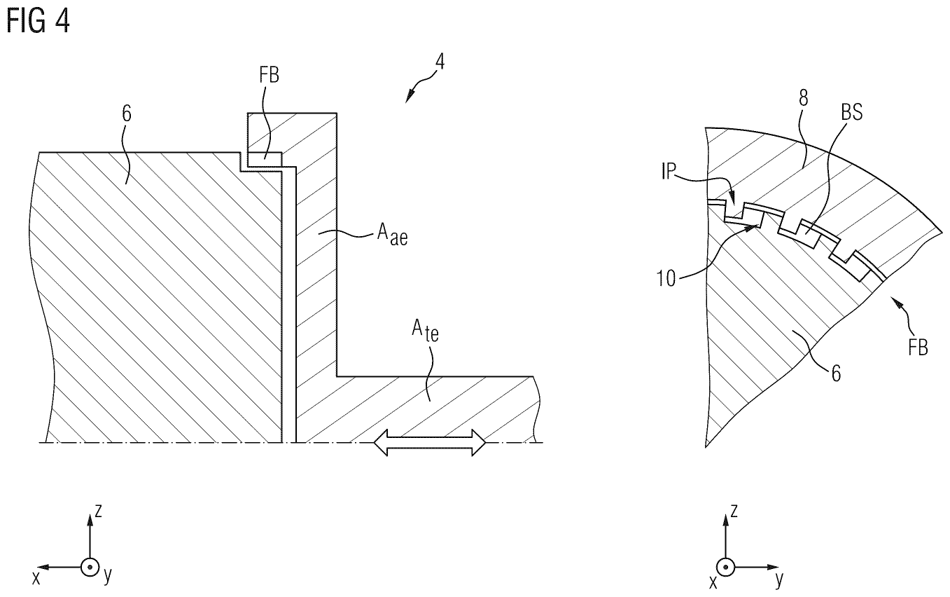

FIG. 4 purely schematically depicts the operative connection between the blocking actuator 4 and the shaft 6. The blocking actuator 4 has a portion Aₐₑ which is axially elastic in the longitudinal direction X-X and a torsionally elastic or torsionally flexible portion Aₜₑ auf.

With reference to FIGS. 1 to 3, this axially elastic portion Aₐₑ is implemented by the individual energy stores 12. Axial impact loadings or impacts in the longitudinal direction X-X in connection with the coupling operation can be reduced via these individual, axially elastic energy stores 12. By contrast, the portion Aₜₑ is realized or implemented by the form-fitting element 8.

Dynamic torque loads in the form of torque peaks of a drivetrain are expressed with respect to the blocking mechanism 2 in the form of impact loadings in the transverse direction Y-Y or Z-Z, which act on the blocking actuator 4 or its form-fitting element 8.

FIG. 4 also depicts the form-fitting region FB between the form-fitting element 8 and the shaft 6 and also a movement clearance BS, which is the basis for this form-fitting region FB, between the inner profiling IP of the form-fitting element 8 and the shaft-mounted profiling or shaft outer profiling 10, specifically in the circumferential direction of the shaft 6.

This movement clearance BS makes it possible to block the shaft 6 using the form-fitting element 8 as soon as the shaft 6 reaches a corresponding alignment relative to the form-fitting element 8, which is required for a form fit or coupling of the elements 6, 8 to be coupled.

In connection with the aforementioned vehicle, this means that the vehicle can be blocked, for instance at the driver's request, in a parked situation in which the vehicle is stationary.

Provided that the alignment of the shaft 6 is not such in this parked situation that it enables the blocking by the form-fitting element 8, the form-fitting element 8, in a state in which it bears against the end face of the shaft 6, can be biased longitudinally in relation to the shaft 6 and with a definable force against the shaft 6 via the three helical springs 12 to form a latching engagement. If the shaft 6 is subsequently turned or rotated only somewhat further, the form-fitting element 8 enters a latching engagement with the shaft 6 as soon as an alignment of the shaft 6 which enables the latching engagement is reached. Such a further rotation (turn) of the shaft 6 in the parked situation can be permitted by the vehicle system.

However, the movement clearance BS also enables the following emergency scenario in the event of a fault during which the electric motor EM of the electric motor drive unit EM-AE fails.

If, in the case of the aforementioned vehicle while it is being driven, the electric motor EM of the electric motor drive unit EM-AE fails and the vehicle is then braked on a road with an incline until it is stationary, then the blocking mechanism 2 described above makes it possible to block the vehicle if it then starts to move from the stationary position, specifically up to a maximum rotational speed of the shaft 6 or maximum speed of the vehicle that depends on the movement clearance BS.

The form-fitting element 8 is brought into latching engagement with the shaft 6 utilizing the movement clearance BS and up to the maximum rotational speed of the shaft 6 or maximum speed of the vehicle that depends on the movement clearance BS, in that the form-fitting element 8, in a state in which it bears against an end face of the shaft 6, is biased longitudinally in relation to the shaft 6 and with a definable force against the shaft 6 via the three helical springs 12 until a latching engagement is obtained. Lastly, the latching engagement is effected as soon as the shaft 6 reaches a corresponding alignment in relation to the form-fitting element 8.

Although exemplary embodiments are explained in the above description, it should be noted that numerous modifications are possible. It should be noted, furthermore, that the exemplary embodiments are merely examples which are in no way intended to limit the scope of protection, the applications, and the structure. Instead, the above description gives a person skilled in the art a guideline for the implementation of at least one exemplary embodiment, it being possible to make various changes, especially with regard to the function and arrangement of the component parts described, without departing from the scope of protection as emerges from the claims and combinations of features that are equivalent thereto.

What is claimed is:

1. A blocking mechanism for a vehicle, the blocking mechanism comprising:
a blocking actuator of a drivetrain of the vehicle;
a blockable shaft of the drivetrain; and
a form-fitting element being part of the blocking actuator and being actuated between the blocking actuator and the blockable shaft, the form-fitting element is actuated in an axial stroke movement and longitudinally in relation to the blockable shaft, wherein:
in a state where the form-fitting element bears against an end face of a shaft-mounted complement to which the form-fitting element is partially form-fittingly coupled, the form-fitting element is biased longitudinally in relation to the shaft and in defined manner against the shaft-mounted complement by way of at least one elastic force transmission portion to form a latching engagement,
in a blocked state of the blockable shaft, the form-fitting element and the shaft-mounted complement engage in one another in a form-fitting region of the blocking mechanism, the form-fitting element is supported against a housing portion of an electric motor drive unit, on which the blocking actuator is mounted, and, in the form-fitting region and in a circumferential direction of the blockable shaft, the blocking mechanism has a movement clearance between the form-fitting element and the shaft-mounted complement.

2. The blocking mechanism of claim 1, wherein the shaft-mounted complement is arranged in the region of an end of the shaft.

3. The blocking mechanism of claim 2, wherein the blocking actuator is mounted on the housing portion in a way situated opposite the end of the shaft.

4. The blocking mechanism of claim 3, wherein the form-fitting element is arranged coaxially with the shaft.

5. The blocking mechanism of claim 1, wherein the form-fitting element is shaped in the form of an annular element that runs around in closed fashion.

6. The blocking mechanism of claim 1, wherein the form-fitting element has an inner profiling which form-fittingly interacts with a complementary profiling of the shaft-mounted complement in the form-fitting region.

7. The blocking mechanism of claim 1, wherein the form-fitting element has an outer profiling being complementary to a guide portion of the blocking actuator or of the housing portion, via which guide portion the form-fitting element is longitudinally guided for the axial stroke movement and via which guide portion the form-fitting element is indirectly or directly supported against the housing portion.

8. The blocking mechanism of claim 1, wherein the form-fitting element is supported against a housing portion of an electric motor housing or of a gear housing.

9. The blocking mechanism of claim 1, wherein the form-fitting element is electrically actuatable.

10. The blocking mechanism of claim 1, wherein the form-fitting element is attached to a movement mechanism of the blocking actuator via the at least one elastic force transmission portion, which movement mechanism brings about the axial stroke movement of the form-fitting element.

11. The blocking mechanism of claim 10, wherein the movement mechanism has a screw drive for generating the axial stroke movement.

12. The blocking mechanism of claim 10, wherein the movement mechanism has a plunger coil for generating the axial stroke movement.

13. An electric motor drive unit having a blocking mechanism of claim 1.

14. A vehicle having an electric motor drive unit of claim 13.

15. A method for blocking a shaft of a drivetrain for a vehicle, by a blocking mechanism, the method comprising:
providing a blocking actuator of a drivetrain of the vehicle;
providing a blockable shaft of the drivetrain;
providing a form-fitting element being part of the blocking actuator;
actuating the form-fitting element between the blocking actuator and the blockable shaft, the form-fitting element is actuated in an axial stroke movement and longitudinally in relation to the blockable shaft; and
engaging the form-fitting element with the shaft-mounted complement into latching engagement by utilizing a movement clearance, up to a maximum rotational speed of the shaft that depends on the movement clearance, the form-fitting element, in a state in which it bears against an end face of the shaft-mounted complement, is biased longitudinally in relation to the shaft and with a definable force against the shaft-mounted complement via the at least one elastic force transmission portion until a latching engagement is obtained.

16. The method of claim 15, wherein when the vehicle starts to move from a stationary position, a shaft of the vehicle is blocked up to a maximum speed of the vehicle that depends on the movement clearance.
